(19) United States
(12) Patent Application Publication
(10) Pub. No.: US 2018/0244443 A1
(43) Pub. Date: Aug. 30, 2018

(54) Venting Overcap for Container

(71) Applicant: Sonoco Development, Inc., Hartsville, SC (US)

(72) Inventor: James P. Stevens, Ford Mill, SC (US)

(21) Appl. No.: 15/755,078

(22) PCT Filed: Aug. 26, 2016
(86) PCT No.: PCT/US16/48988

§ 371 Date: Feb. 25, 2018

Related U.S. Application Data
(60) Provisional application No. 62/213,894, filed on Sep. 3, 2015.

(51) Int. Cl. B65D 51/16; B65D 51/20; A23F 5/10

(52) U.S. Cl. CPC B65D 51/1644; B65D 51/1622; B65D 2251/0018; A23F 5/105; B65D 2251/0093; B65D 51/20

(57) ABSTRACT

A container is provided having an open top end defining an access opening into an interior storage volume. A peripheral rim surrounds the access opening. A flexible membrane is sealed to the peripheral rim and a valve is attached to the membrane for venting gases from the interior of the container body. An overcap is provided to cover the access opening and be retained in the container rim adjacent the membrane. A bottom surface of the body of the overcap includes a continuous surface pattern thereon, with the surface pattern creating a plurality of gaps that define a continuous passageway along the bottom surface to the periphery of the overcap.

### RELATED APPLICATION

The present application claims priority to and the benefit of the filing date of U.S. provisional patent application No. 62/213,894, filed Sep. 3, 2015.

### FIELD OF THE INVENTION

The present invention relates to an overcap for releasably closing an opening into a container or package.

### BACKGROUND OF THE INVENTION

Easy-open containers are used for a variety of products, including powdered materials, such as food products, cleaning products, etc. Easy-open containers are often constructed of a cylindrical body portion having an end closure for sealing the container body. In some examples, the top end of the container body may include a bead formed around the rim of the container opening. The bead may be integrally formed with the sidewalls of the container body or may be a separately formed end ring that is fixed to the rim.

An inwardly projecting flange is sometimes provided as part of the container structure, with the flange defining the opening for access to the contents of the container. The flange may be integrally formed as part of the container body or may be formed as a part of a separate rim structure that is attached to the container opening. The defined opening formed by the flange may be spaced inwardly with respect to the rim and sidewall of the container.

A removable membrane patch is sometimes provided to cover the container opening. The membrane may be attached to the rim or to the flange surface. The membrane serves to seal the container contents and may provide an indication of tampering prior to opening the container. The membrane is removed from the container body, providing access to the contents therein.

An overcap may be provided on the container body, fitting over container opening. The overcap typically serves many functions, including, but not limited to, protecting the top of the container from damage before and after removal of the membrane, keeping unwanted items from getting into the container, keeping the product within the container from spilling, helping to improve stacking of the container, and increasing the useful life of the product after removal of the membrane.

Some products, such as roasted or ground coffee, tend to generate gases for a period of time after their preparation. Ground coffee often releases carbon dioxide and other gaseous substances for days or weeks after the grinding process. Because of this gas release, sometimes called “off-gassing”, it is customary to store the coffee in packaging that can expand or that has a release vent for the gas. Flexible packaging having a one-way gas release valve thereon is shown in, for example, Goglio U.S. Pat. No. 3,595,467, Donke U.S. Pat. No. 5,326,176 and Walters U.S. Pat. No. 5,992,635. Rigid and semi-rigid containers with venting valves are shown in, for example, Gunter et al. U.S. Pat. No. 7,294,354 and Thomas et al. U.S. Pat. No. 7,074,443.

When a membrane patch is provided on a container for retaining materials subject to off-gassing, a certain amount of flexing may occur in the membrane. A venting valve is sometimes positioned on the membrane for releasing the gas pressure within the container. In the Thomas et al. patent mentioned above, a localized stand-off fixture is provided on the overcap to space the valve from the underside surface of the cap body. The Thomas et al. stand-off fixtures are shown to be a formed pocket within the surface of the overcap or a pattern of three raised bosses on the underside surface of the cap body. Another method of avoiding interference between the valve and the overcap is to position the valve in a position that prevents it from engaging the overcap during expansion of the membrane. As a further alternative, in the Gunter et al. patent mentioned above, the valve is provided on the outer surface of the container.

Another feature of overcaps that is sometimes included is a vent at the position of the engagement between the overcap and the rim of the container body. Various rib formations creating a rim vent are shown in, for example, Clougherty U.S. Pat. No. 7,337,916, Holder et al. U.S. Pat. No. 3,381,872 and Beall, Jr. U.S. Pat. No. 3,043,463.

### SUMMARY OF THE INVENTION

A container is defined for retaining a product that creates a gas buildup, such as ground coffee. The container includes a body portion having a sidewall, a bottom wall and an open top end and defines an interior storage volume for retaining the product. The container body includes an access opening into the interior storage volume at its top end, with the top end including a peripheral rim. A flexible membrane covers the access opening and is releasably sealed to the peripheral rim. A valve is attached to the flexible membrane for venting gas buildup from the interior storage volume when sealed by the membrane. An overcap is provided and includes a body portion formed to cover the access opening and a depending skirt that surrounds a periphery of the body portion and engages the top end of the sidewall of the container body. The bottom surface of the body portion is closely positioned with the membrane and the valve, when the overcap body covers the access opening. The bottom surface of the overcap includes a surface pattern thereon that creates a spacing structure and defines one or more continuous passageways. The continuous passageways of the surface pattern prevent the valve and membrane from blocking gas release from the valve when the membrane is pushed toward the bottom surface of the overcap by the product gases built-up within the interior volume.

In a further aspect of the container, the surface pattern includes a plurality of hills and valleys extending substantially across the bottom surface of the body portion of the overcap. The plurality of hills and valleys may be formed by a plurality of nubs spaced from one another on the bottom surface. Further, the plurality of nubs may be arranged in a regular pattern and the pattern may include a plurality of rows of nubs. In addition, the rows of nubs may be arranged in an offsetting relationship and the nubs may include an oval perimeter.

In a further aspect of the container a rim passageway may be provided that extends from the space between the membrane and overcap and around the rim of the container body to the exterior. The rim passageway may be formed by a vent channel within the depending skirt, with the vent channel communicating with the one or more continuous passageways of the surface pattern. Further, a plurality of raise ribs may be provided on the periphery of the bottom surface of the overcap body. The raised ribs may be positioned adjacent the rim of the container body. In addition, the flexible membrane may be peelable from its attachment to the rim of the container body. Moreover, the product retained by the container may be ground or whole bean roasted coffee.

Further features and aspects of the contemplated invention are defined by the drawings and description below.

### BRIEF DESCRIPTION OF THE DRAWINGS

For purposes of illustrating the invention, there is shown in the accompanying drawings a form that is presently preferred; it being understood, however, that the invention is not limited to the precise arrangements and instrumentalities shown.

FIG. 1 shows an isometric view of a container or package having an overcap positioned on a top end of a container body.

FIG. 2 shows an exploded isometric view of the container of FIG. 1.

FIG. 3 is a side elevation of the container of FIGS. 1 and 2.

FIG. 4 is a cross section view of the container as taken along line 4-4 in FIG. 3.

FIG. 5 is an enlarged cross section view of a rim portion of the container of FIG. 4.

FIG. 6 is an enlarged cross section view of a central portion of the rim of the container of FIG. 4.

FIG. 7 is an isometric view of the bottom surface of the overcap portion of the container.

FIG. 8 is an enlarged view of a portion of the overcap of FIG. 7.

### DETAILED DESCRIPTION OF DRAWINGS

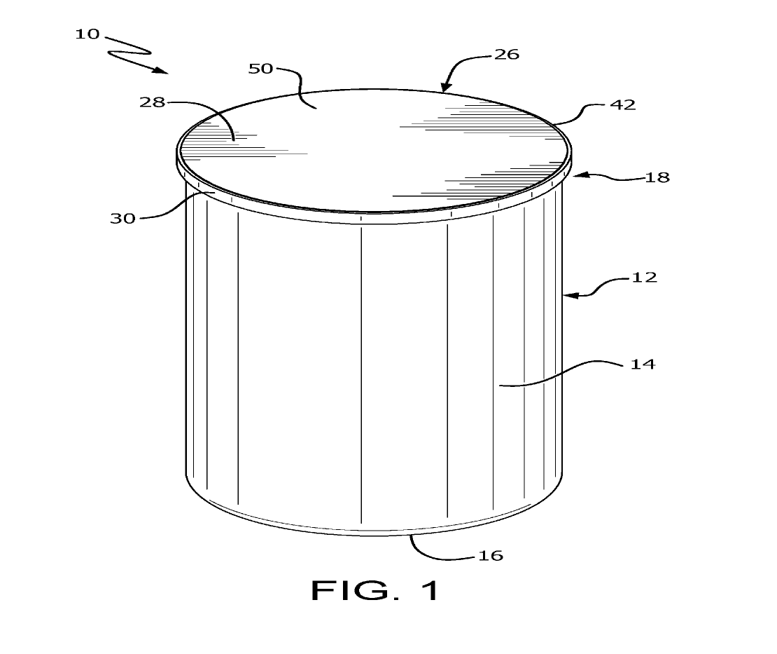

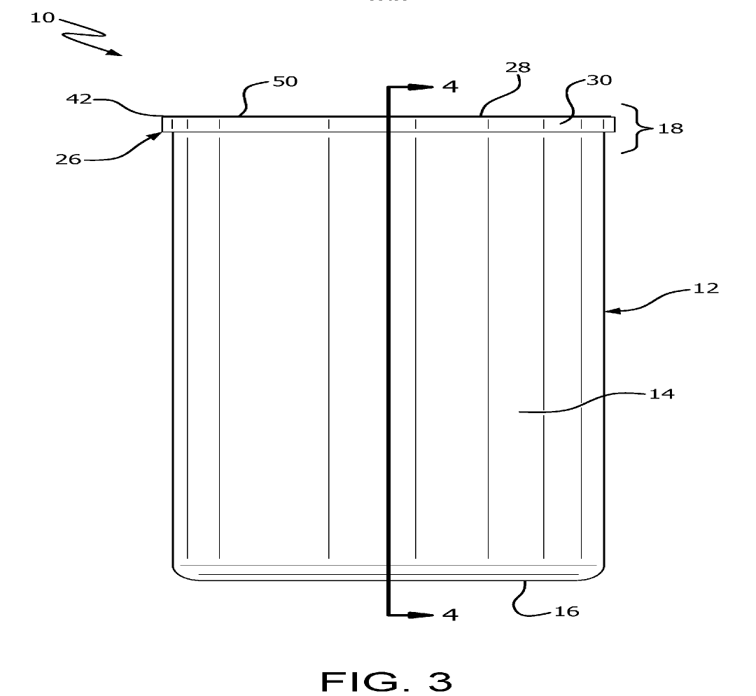

Referring now to the drawings, where like numerals identify like elements, there is shown in FIGS. 1-4 a container or package that is generally identified by the numeral 10. The container 10 is adapted to be filled with a product (not shown), such as powdered or granulated food products, cleaning products, etc. In a preferred use, the container 10 retains ground coffee or other products that may cause off-gassing during storage in the container. The container 10 may be of any desired shape and may be constructed of any desired material including composites, plastic, metal, etc. As shown, the container 10 has a generally cylindrical shape. Other shapes and profiles are contemplated.

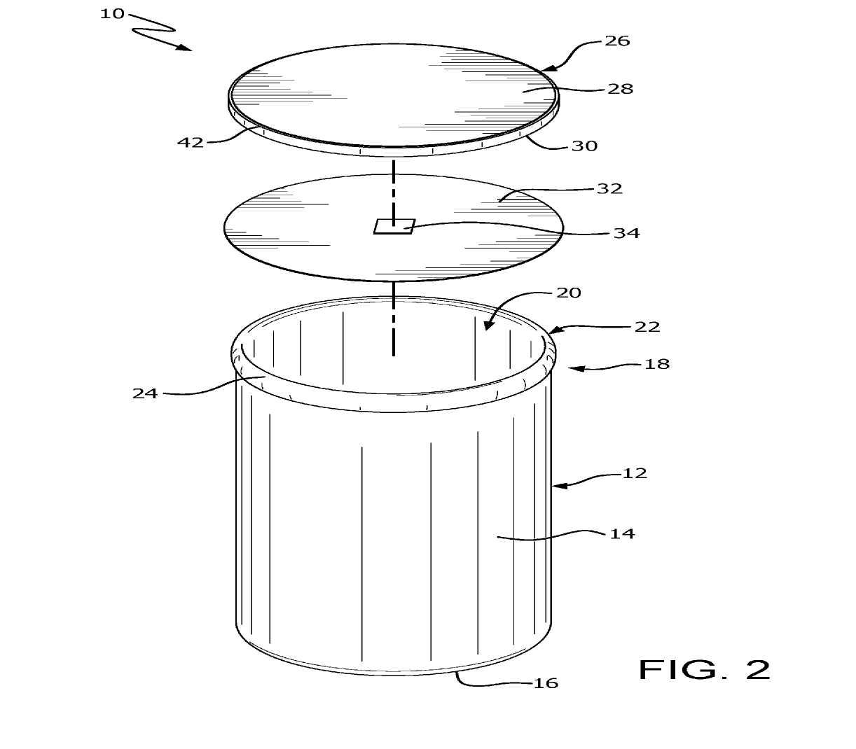

The container 10 comprises a generally cylindrical container body 12 having a cylindrical sidewall 14 and a bottom wall 16. The sidewall 14 and the bottom wall 16 generally define an interior storage volume. As more particularly shown in FIG. 2, the container 10 includes a top end 18 defining an opening 20 into the interior of the container body 12. A defined closure structure (not shown) may be attached to the top end of the container body. The bottom wall 16 may be integrally formed with the sidewall 14 or attached to the bottom end of the sidewall 14. The container body 12 may include multiple sidewalls. The top end 18 of the container body 12 forms a rim structure 22 having a projecting bead portion 24. The rim 22 surrounds the defined opening 20. Other forms of container openings may be utilized. For example, the rim may include an inwardly or outwardly projecting flange structure. The flange may further define the container opening for access to the interior of the container. The flange may be integrally formed as part of the container body or may be formed as a part of a separate rim structure that is attached to the container sidewall. The access opening may be spaced inwardly with respect to the rim and sidewall of the container.

Attached to the rim 22 of the container 10 is an overcap 26 formed to cover the opening 20 and overlap the top end 18 of the container body 12. The overcap 26 comprises a body portion 28 and a depending skirt 30. The top surface 50 of the overcap body 28 is illustrated in FIGS. 1 and 2, with the skirt 30 depending in a substantially perpendicular fashion from a peripheral edge of the body 28.

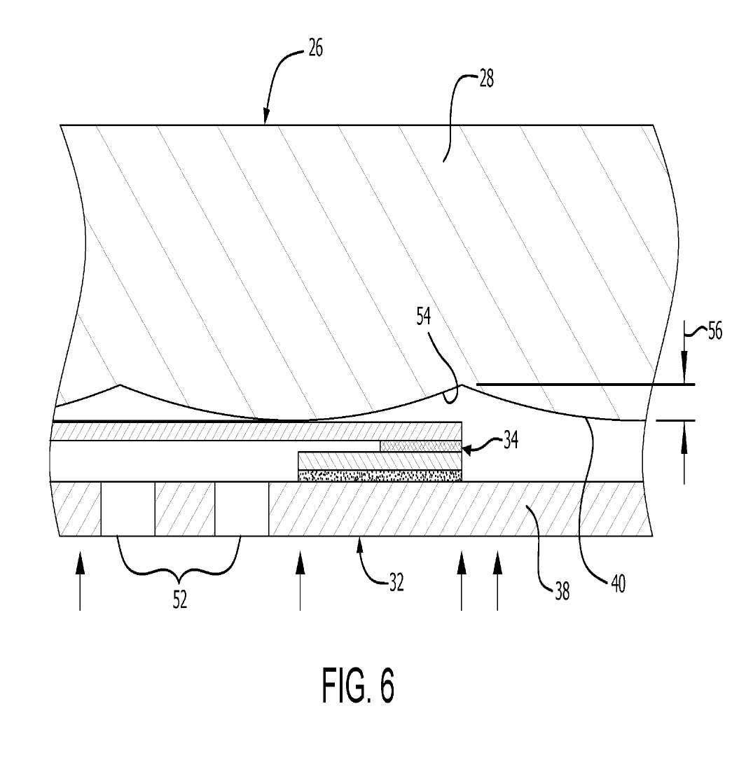

As shown in FIG. 2, a flexible membrane 32 is provided between the rim 22 of the container body 12 and the underside of the overcap body 28. A one way venting valve 34 is attached to the membrane 32. The valve 34 may take any number of forms, including those shown and described in the patents mentioned above. The valve 34 is adhered to the surface of the membrane 32 and overlies one or more holes or openings 52 (see FIG. 6) in the membrane 32.

The membrane 32 covers the container opening 20 and is sealed to the container rim 22. The valve 34 communicates with the interior volume of the container body 12. As shown, the valve 34 is positioned in the center of the membrane 32. The membrane 32 is removable from the rim 22 to provide access to the container contents through the opening 20.

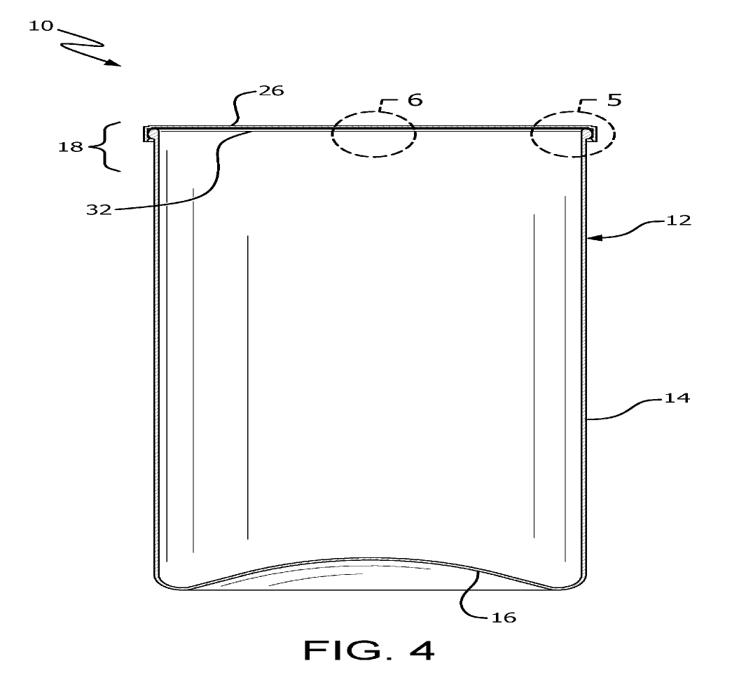

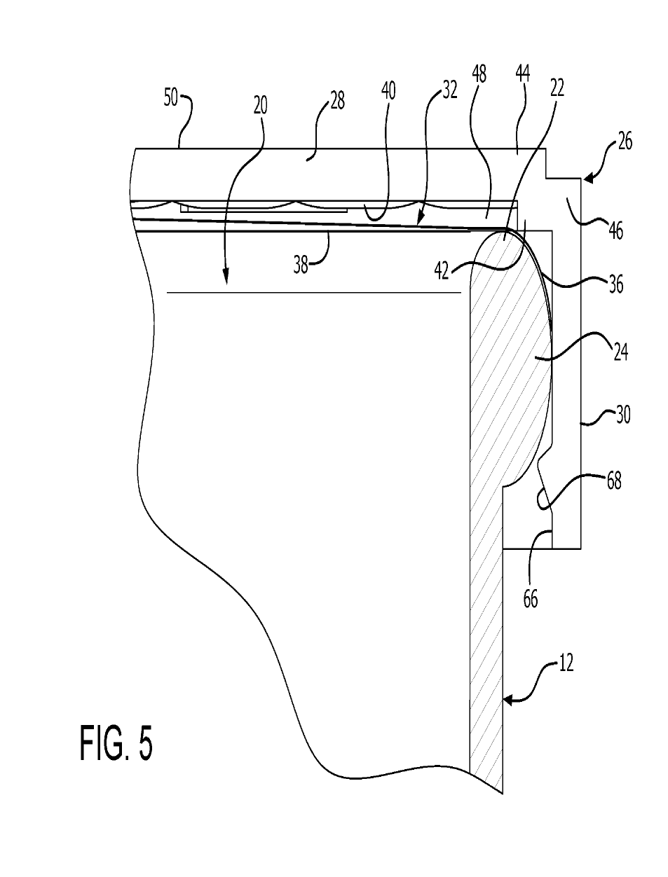

In the cross sections of FIGS. 4-6 there is shown the assembled relationship between the overcap 26, membrane 32 and top end 18 of the container body 12. The overcap 26 is resiliently retained on the rim 22 of the container body 12 by the interaction of the skirt 30 and the projecting bead 24. The membrane 32 is attached to the rim 22 by an adhesive, heat seal or other method. As shown in FIG. 5, an extension portion 36 of the membrane 32 extends past the top edge or chime portion of the rim 22 and wraps over a portion of the bead 24. During assembly, it is contemplated that the rim of the container will be sealed to a sheet of membrane material and cut to size afterwards. The membrane material will be cut radially outward of the seal position. with the excess edge portion 36 wrapping around at least a portion of the bead 24.

The center portion 38 of the membrane 32 extends across and covers the container opening 20. A space is formed between the membrane center portion 38 and the bottom surface 40 of the overcap 26. A step 42 is created at the intersection of the periphery 44 of the overcap body 28 and the top edge 46 of the skirt 30. As seen in, for example, FIG. 4, the step 42 may also be created on the periphery of the top surface 50 of the overcap body 28. The top step formation may serve as a centering support when stacking containers. Other structures may also be provided on the top surface 50 of the overcap 26.

The valve 34 is positioned on the center membrane portion 38 as is shown in FIG. 6. The valve 34 is attached above holes 52 in the membrane 32. The view in FIG. 6 shows the valve 34 in contact with the bottom surface 40 of the overcap body 28, which may result from the pressure buildup within the container created by off-gassing. The internal pressure is illustrated by upward arrows. It is also possible that the membrane material will contact the bottom surface 40 of the overcap 26. A channel is formed on the bottom surface 40 of the overcap 26 by means of a surface pattern 54 that creates a series of defined gaps 56. Gas released through the valve 34 into the space 48 between the membrane 32 and the bottom surface 40 of the overcap 26 migrates away from the valve 34 through the gaps 56. The combination of the gaps 56 creates a continuous channel across the bottom surface 40 of the overcap 26, regardless of contact between the membrane 32 and the bottom surface 40.

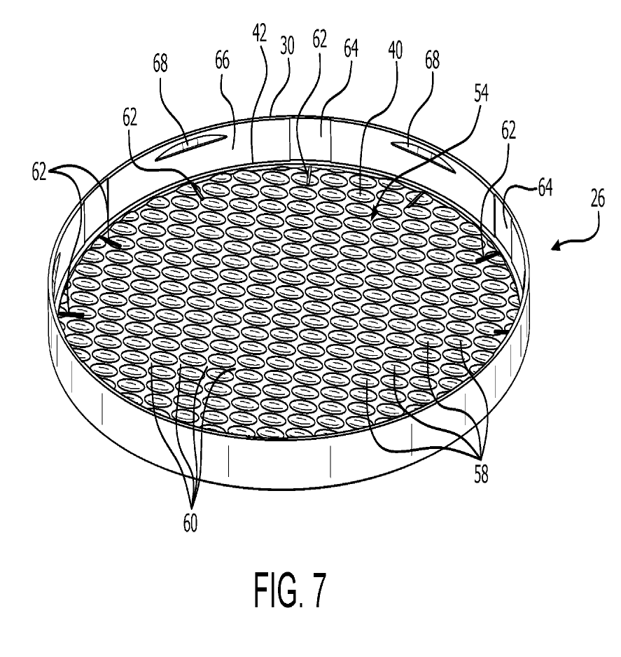

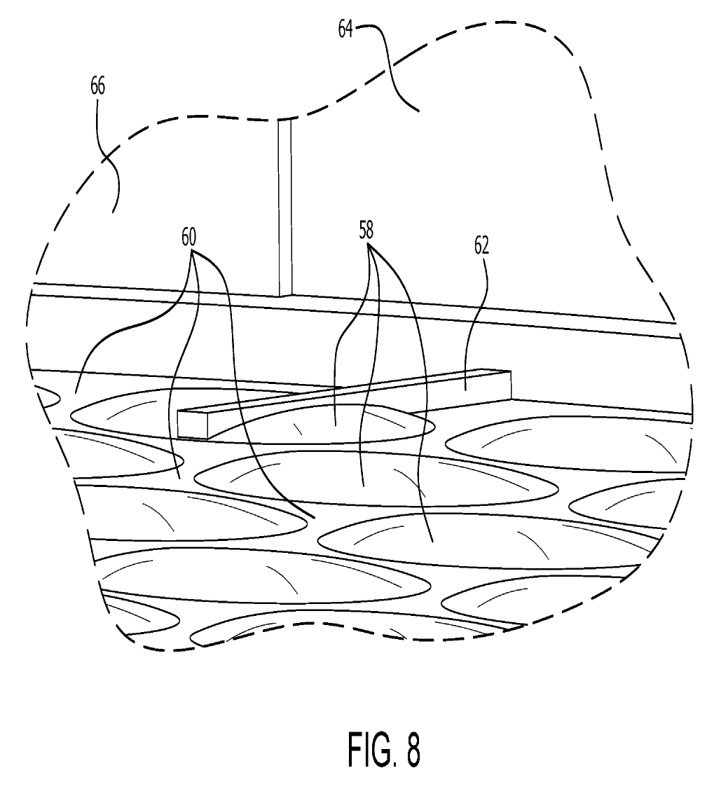

The surface pattern 54 is more particularly shown in FIGS. 7 and 8 and includes a series of oval nubs 58 formed in offset rows along the overcap surface 40. Spaces 60 between the nubs 58 create the gaps 56 shown in FIG. 6. The nubs 58 and spaces 60 are shown in the drawings to be uniformly arranged. An irregular pattern may also be utilized.

The pathway created by the surface pattern extends substantially continuously across the bottom surface of the overcap body from the position of the valve on the membrane to the overcap skirt. The surface pattern results in a connected series of gaps generally defined by a multitude of small hills and valleys. The continuous channel creates a pathway for the gas to escape from the container. Without the surface pattern providing sufficient spacing on the bottom surface, the valve may not be able to open and the gas may not be able to escape. Hence, the surface pattern is used as part of the system to relieve the pressure buildup within the sealed container due to off-gassing or the like.

The pattern may include a marbled or textured surface, such as a grain or pebbled formation. Although a number of factors may affect operation, the gap is preferably at least about 0.005 inches. Variation in the depth of the valleys and the height of the hills is acceptable. The spacing between the hills may also vary. The general intent is to make it difficult for the membrane to seal against the valley portions, closing the desired gaps. The hills and valleys of the surface pattern on the overcap bottom surface are preferably created during the molding process of the overcap. The pattern within the mold surfaces may be created by any number of processes, including photo-chemical etching process, laser or electrical discharge engraving, etc.

A series of stand-off ribs 62 are provided around the periphery of the bottom surface 40 of the overcap 26. The ribs 62 contact the top of the rim 22 of container body 12 to create a passage between the bottom surface 40 of the overcap 26 and the rim 22. The ribs 62 may function in combination with the step 42. The ribs 62 project radially inward from the step 42 and the skirt 30. A series of skirt channels 64 are provided on the inside surface 66 of the skirt 30. The skirt channels 64 preferably align with the ribs 62 and to provide a passage for gas to migrate around the container rim 22 and its associate bead 24.

A series of retention bars 68 are spaced around the inside surface 66 of the skirt. The retention bars 68 are formed to engage under the projection of the bead 24 to resiliently retain the overcap 26 on the top end 18 of the container body 12. The bars 68 are preferably spaced from one another, creating gaps. As illustrated, one skirt channel 64 is provided between two retention bars 68.

As shown in FIGS. 4-6, the space 48 between the membrane 32 and the bottom surface 40 of the overcap body 28 is contemplated to be relatively small. Generally, the greater the space between the membrane and overcap, the lesser the maximum quantity of product that may be retained within a container of a given volume. Alternatively, the closer the membrane is positioned to the bottom surface of the overcap, the lower the pressure buildup within the container interior will be before the membrane contacts the bottom surface of the overcap. The amount of flexing of the membrane will be dependant on a number of factors, including the flexibility of the membrane material, the transverse dimension (diameter) of the container opening, the function of the valve, etc.

In FIGS. 7 and 8, the surface pattern 54 is continuous over the bottom surface 40 of the overcap body 28. The nubs 58 and spaces 60 are shown to extend to the outer periphery 44 of the bottom surface, up to engagement with the step structure 42. The surface pattern may vary over the surface area of the bottom surface of the overcap. In addition, depending on a number of factors, such as the flexibility of the membrane, the position of the rim and container opening, etc., the surface pattern need not extend all the way to the skirt. However, a substantial portion of the surface area is contemplated to include the surface pattern so as to create the necessary passageway along the bottom surface of the overcap. Without a continuous passageway along the surface of the overcap that is contacted by the valve and membrane, the gas may not be able to escape and the venting system for the container would be rendered ineffective.

The stand-off ribs 62 extend inwardly from the step 42 into the surface pattern 54. In FIG. 7, the ribs 62 extend from the bottom surface 40 a greater distance than the nubs 58. This dimensional relationship is contemplated to create a relatively greater opening or gap at the position of the ribs. As also shown, the edge of the step 42 is shown to be a greater distance from the bottom surface 40 than the ribs. This dimensional relationship defines the space 48 between the rim and the bottom surface 40 of the overcap body 28. The engagement of the edge of the step 42 is contemplated to permit the migrating gas to enter the skirt channels 64. The skirt channels may also be extended into the step to open the passageway.

The structure defined in the drawings and as described herein may take any number of forms. The overcap structure may be varied, without departing from the contemplated functions of the invention. As discussed above, the regular arrangement of nubs and spaces in the surface pattern as shown may be replaced by other regular and irregular patterns. The continuous pattern is formed to provide a continuous passageway or channel for the migration or flow of gas to the ambient environment surrounding the container. Other forms of standoff structures creating a channel adjacent the rim engagement of the overcap rim may also be provided.

In the drawings and specification, there has been set forth an embodiment of the contemplated invention. Within the specification specific terms are employed. These terms are typically used in a generic and descriptive sense and unless specifically stated are not intended for purposes of limitation. The scope of the invention is set forth in the following claims.

What is claimed is:

1. A container retaining a product that creates a gas buildup, the container comprising:
a container body having a sidewall, a bottom wall and an open top end defining an access opening into the interior storage volume, the interior storage volume retaining the product, the top end of the container body including a peripheral rim;
a flexible membrane covering the access opening and releasably sealed to the peripheral rim;
a venting valve attached to the flexible membrane for venting gas buildup from the interior storage volume when sealed by the membrane; and
an overcap comprising
a body portion formed to cover the access opening of the container body,
a depending skirt surround a periphery of the body portion, the skirt engaging the top end of the sidewall of the container body, and
the bottom surface of the body portion closely positioned with the flexible membrane and the valve when the overcap body portion covers the access opening of the container body, the bottom surface having a surface pattern thereon creating a spacing structure defining one or more continuous passageway across the bottom surface,
the surface pattern enabling the valve to function and preventing the membrane from sealing against the bottom surface of the body portion, when the membrane is pushed toward the bottom surface of the overcap by the product gases built-up within the interior volume.

2. A container as in claim 1 wherein the surface pattern comprises a plurality of hills and valleys extending across the bottom surface of the body portion of the overcap.

3. A container as in claim 2 wherein the plurality of hills and valleys are formed by a plurality of nubs spaced from one another on the bottom surface of the overcap body.

4. A container as in claim 3 wherein the plurality of nubs is arranged in a regular pattern across the bottom surface.

5. A container as in claim 4 wherein the regular pattern comprises a plurality of rows of nubs.

6. A container as in claim 5, wherein the rows of nubs are arranged in an offsetting relationship.

7. A container as in claim 3 wherein the nubs have an oval perimeter.

8. A container as in claim 1 further comprising a rim passageway extending from the space between the membrane and overcap and around the rim of the container body to the exterior.

9. A container as in claim 8 wherein the rim passageway is formed by a vent channel within the depending skirt, the vent channel communicating with the one or more continuous passageways of the surface pattern.

10. A container as in claim 9 further comprising a plurality of raise ribs formed on the periphery of the bottom surface of the overcap body, the raised ribs positioned adjacent the rim of the container body.

11. The container of claim 1, wherein the membrane is peelable from its attachment to the rim of the container body.

12. A container as in claim 1 wherein the product is roasted ground or whole bean coffee.

13. A container defining an interior storage volume, the container comprising:
a container body having a sidewall, a bottom wall and an open top end defining an access opening into the interior storage volume, the top end including a peripheral rim;
a flexible membrane covering the access opening and releasably sealed to the peripheral rim;
a valve attached to the flexible membrane for venting gases from the interior storage volume as sealed by the membrane; and
an overcap comprising
a body portion formed to cover the access opening of the container body,
a depending skirt surround a periphery of the body portion, the skirt extending substantially perpendicular from a bottom surface of the body portion for a distance sufficient to overlap the top end of the container body,
the bottom surface of the body portion having a continuous surface pattern thereon creating a plurality of hills and valleys, the surface pattern defining one or more continuous passageway between the hills along the bottom surface to the periphery of the body portion, and
a vent channel formed in the depending skirt, the vent channel communicating with the one or more continuous passageways of the surface pattern.

14. A container as is claim 13 wherein the vent channel comprises a plurality of spacing ribs formed on the bottom surface of the overcap body, the ribs contacting the container rim, and one of more skirt channels formed on an inside surface of the skirt, the skirt channels communicating with the vent channel.

15. A container as in claim 13, wherein the defined surface pattern comprises a plurality of oval nubs spaced from one another on the bottom surface of the overcap body.

16. A container as in claim 15, wherein the plurality of nubs is arranged in a regular pattern across the bottom surface.

17. An overcap for a container of the type having a container body creating an interior storage volume and an open top end, the open top end defining an access opening into the interior storage volume, the top end including a peripheral rim, a flexible membrane covering the access opening and releasably sealed to the peripheral rim, and a valve attached to the flexible membrane for venting gases from the interior storage volume of the container body as sealed by the membrane, the overcap comprising:
a body portion formed to cover the access opening of the container,
a depending skirt surround a periphery of the body portion, the skirt extending substantially perpendicular from a bottom surface of the body portion for a distance sufficient to cover and extend beyond the projecting bead, and
the bottom surface of the body portion having defined surface pattern thereon creating a plurality of gaps within the surface, the gaps defining one or more continuous passageways along the bottom surface to the periphery of the body portion of the overcap.

18. An overcap for a container as is claim 17, further comprising a vent channel formed within the depending skirt, the vent channel communicating with the one or more continuous passageways formed by the defined surface pattern, the vent channel having a plurality of spacing ribs formed on the bottom surface of the overcap body, the ribs contacting the container body adjacent the rim, and one of more skirt channels formed on an inside surface of the skirt, the skirt channels communicating with the vent channel.

19. An overcap for a container as in claim 17, wherein the defined surface pattern comprises a plurality of oval nubs spaced from one another on the bottom surface of the overcap body.

20. An overcap as for a container in claim 19, wherein the plurality of nubs are arranged in a regular pattern across the bottom surface.
